(19) United States
(12) Patent Application Publication
(10) Pub. No.: US 2023/0065108 A1
(43) Pub. Date: Mar. 2, 2023

(54) OPTIMIZATION FUNCTION GENERATION APPARATUS, OPTIMIZATION FUNCTION GENERATION METHOD, AND PROGRAM

(71) Applicant: NIPPON TELEGRAPH AND TELEPHONE CORPORATION, Tokyo (JP)

(72) Inventors: Kazuhiro MIYAHARA, Musashino-shi, Tokyo (JP); Keitaro HORIKAWA, Musashino-shi, Tokyo (JP); Kinya TOMITA, Musashino-shi, Tokyo (JP)

(73) Assignee: NIPPON TELEGRAPH AND TELEPHONE CORPORATION, Tokyo (JP)

(21) Appl. No.: 17/799,938

(22) PCT Filed: Mar. 5, 2020
(86) PCT No.: PCT/JP2020/009313

§ 371 Date: Aug. 16, 2022

(51) Int. Cl. G06Q 10/04; G06Q 10/06; G06Q 10/08; G06N 10/60

(52) U.S. Cl. CPC G06Q 10/04; G06Q 10/0631; G06Q 10/083; G06N 10/60

(57) ABSTRACT

A technique for solving a delivery planning problem for delivering a vehicle to a parking lot short of vehicles to be parked. Included are an input setting unit that sets a set of staff members, a set of vehicles, a set of parking lots, a delivery end time, parking lots with a staff member being present at a delivery start time, a staff cost per unit time, a parking lot with a vehicle being present at the delivery start time, a vehicle cost per unit time, a maximum value of staff members capable of boarding the vehicle, a set of parking lots neighboring to the parking lot, a time period required for moving from the parking lot to a parking lot neighboring to the parking lot, and the number of vehicles to be still accommodated in the parking lot as input.

### TECHNICAL FIELD

The present invention relates to a technique for generating an optimization function for solving a combinatorial optimization problem by a quantum computer.

### BACKGROUND ART

It is said that it is difficult to efficiently solve combinatorial optimization problems by von Neumann computers widely used today. Thus, in recent years, research and development are undertaken for quantum annealing machines, Ising machines, or the like, which are a computing machine capable of solving combinatorial optimization problems more efficiently than von Neumann computers.

When these new computing machines are input with an optimization function in which a combinatorial optimization problem to be solved is expressed by an objective function of a QUBO (Quadratic Unconstrained Binary Optimization) or an Ising Hamiltonian, it is possible to calculate a solution of the combinatorial optimization problem at high speed.

In the related art, methods of designing a graph partitioning problem, a graph clique problem, and a graph isomorphism problem as a QUBO objective function or as an Ising Hamiltonian have been devised (see NPLs 1, 2, 3, and 4).

### CITATION LIST

### Non Patent Literature

NPL 1: A. Lucas, “Ising formulations of many NP problems”, frontiers in Physics (2014), [online], [searched on Jan. 17, 2020], Internet <URL: https://www. frontiersin. org/articles/10.3389/fphy.2014.00005/full>
NPL 2: D-Wave Systems Inc, “The D-Wave 2000 QTM Quantum Computer Technology Overview”, [online], [searched on Jan. 17, 2020], Internet <URL: https://www.dwavesys.com/sites/default/files/D-Wave%202000Q%20Tech%20Collateral_1029F.pdf>
NPL 3: Takahiro Inagaki et al., “A coherent Ising machine for 2000-node optimization problems”, Science, vol. 354, Issue 6312, pp. 603-606, 2016.
NPL 4: N. Yoshimura, M. Tawada, S. Tanaka, J. Arai, S. Yagi, H. Uchiyama, and N. Togawa, “An efficient ising model mapping method to solve induced subgraph isomorphism problems using ising machines”, Adiabatic Quantum Computing Conference 2019.

### SUMMARY OF THE INVENTION

### Technical Problem

One example of a combinatorial optimization problem is a delivery planning problem in which a vehicle is delivered to a parking lot short of vehicles to be parked, under various types of constraints on staff members, vehicles, and parking lots, and thus, it is expected that a solution thereto can be obtained at high speed by using a quantum annealing machine or an Ising machine. However, NPLs 1 to 4 and the like only disclose a QUBO objective function and an Ising Hamiltonian for solving a certain problem related to a graph, whereas a QUBO objective function and an Ising Hamiltonian for the above-mentioned delivery planning problem are not known.

Thus, an object of the present invention is to provide a technique for generating an optimization function for variables representing quantum states for solving a delivery planning problem in which a vehicle is delivered to a parking lot short of vehicles to be parked, under various types of constraints on staff members, vehicles, and parking lots.

### Means for Solving the Problem

An aspect of the present invention provides an input setting unit that sets a set of staff members S, a set of vehicles C, a set of parking lots P, a delivery end time Close, a parking lot s.init (∈ P) with a staff member s (∈ S) being present at a delivery start time, a cost s.cost for the staff members per unit time, a parking lot c.init (∈ P) with a vehicle c (∈ C) being present at the delivery start time, a cost c.cost for the vehicle c per unit time, a maximum value c. capacity of staff members capable of boarding the vehicle c, a set of parking lots p.neighbors (⊆ P) neighboring to a parking lot p (∈ P), a time period p.time (q) required for moving from the parking lot p to the parking lot q (∈ p.neighbors) neighboring to the parking lot p, and a number p.shortage of vehicles to be still accommodated in the parking lot p as input of a delivery planning problem for generating, under predetermined constraint conditions, a plan for delivering a vehicle to a parking lot short of vehicles to be parked, so as to satisfy a condition for minimizing a total of a staff cost and a vehicle cost incurred until the delivery end time Close (hereinafter, referred to as an optimization condition), and an optimization function generation unit that generates an optimization function for variables representing quantum states for solving the delivery planning problem by using the input.

### Effects of the Invention

According to the present invention, it is possible to generate an optimization function for variables representing quantum states for solving a delivery planning problem with predetermined constraint conditions.

### BRIEF DESCRIPTION OF DRAWINGS

FIG. 1 is a table showing an example of an input in a delivery planning problem.

FIG. 2 is a table showing an example of an output in the delivery planning problem.

FIG. 3 is a block diagram illustrating a configuration of an optimization function generation apparatus 100.

FIG. 4 is a flowchart illustrating an operation of the optimization function generation apparatus 100.

FIG. 5 is a diagram illustrating an example of a functional configuration of a computer achieving each apparatus according to an embodiment of the present invention.

### DESCRIPTION OF EMBODIMENTS

Hereinafter, embodiments of the present disclosure will be described in detail. Note that components having the same functions are denoted by the same reference signs, and redundant description thereof will be omitted.

Prior to describing each embodiment, the method of notation herein will be described.

\hat{ } (caret) represents the superscript. For example, x^{yΛz} represents y^{z} is the superscript to x, and x_{yΛz} represents y^{z} is the subscript to x. _(underscore) represents the subscript. For example, x^{y_z} represents y_{z} is the superscript to x, and x_{y_z} represents y_{z} is the subscript to x.

A superscript “\hat{ }” or “˜”, such as \hat{ }x or ˜x to a character x, should be described otherwise above “x”, but are described as \hat{ }x or ˜x, under the limitations of the written description herein.

### <Technical Background>

A combinatorial optimization problem handled in the embodiments of the present invention is a delivery planning problem in which under predetermined constraint conditions, a plan for delivering a vehicle to a parking lot short of vehicles to be parked is generated so as to satisfy a condition for minimizing a total of a staff cost and a vehicle cost incurred until a delivery end time Close (hereinafter, referred to as an optimization condition). Here, the predetermined constraint conditions include six constraints, that is, a “constraint on riding a vehicle”, a “constraint on exiting a vehicle”, a “constraint on a transportation means”, a “constraint dictating that the vehicle moves to a neighboring parking lot”, a “constraint on a vehicle capacity”, and a “constraint dictating that a parking lot is filled with vehicles”. These six constraints will be described below.

### (1) Constraint on Riding Vehicle

The constraint on riding a vehicle is a condition that, when a staff member moves on a vehicle, a parking lot with the staff member being present before the movement coincides with a parking lot with the vehicle being present.

### (2) Constraint on Exiting Vehicle

The constraint on exiting a vehicle is a condition that, when a staff member moves on a vehicle, a parking lot with the staff member being present after the movement coincides with a parking lot with the vehicle being present.

### (3) Constraint on Transportation Means

The constraint on a transportation means is a condition that a staff member moves only by riding a vehicle.

(4) Constraint Dictating that Vehicle Moves to Neighboring Parking Lot

The constraint dictating that the vehicle moves to a neighboring parking lot is a condition that a vehicle moves to a neighboring parking lot in one movement.

### (5) Constraint on Vehicle Capacity

The constraint on a vehicle capacity is a condition that the number of staff members on board when the vehicle moves is from one to the maximum number of passengers.

(6) Constraint Dictating that Parking Lot is Filled with Vehicles

The constraint dictating that a parking lot is filled with vehicles is a condition that delivery is completed in a state where each parking lot is filled with a number of vehicles to be still accommodated in the parking lot.

Next, an input and an output in the delivery planning problem will be described.

### (1) Input

The input in the delivery planning problem is as follows.
A set S of staff members in charge of delivery work (hereinafter, referred to as a set of staff members)
A set C of vehicles to be delivered (hereinafter, referred to as a set of vehicles)
A set P of parking lots that are delivery locations (hereinafter, referred to as a set of parking lots)
A delivery end time Close (∈ N) (where N represents a set of natural numbers)
   In addition, the following values are input for each staff member s ∈ S.
A parking lot s.init (∈ P) with a staff member s being present at a delivery start time (hereinafter, referred to as an initial position)
Cost s.cost (∈ N) for the staff member s per unit time
   In addition, the following values are input for each vehicle c ∈ C.
A parking lot c.init (∈ P) with the vehicle c being present at the delivery start time (hereinafter, referred to as an initial position)
Cost c.cost (∈ N) for the vehicle c per unit time
A maximum value c.capacity (∈ N) of staff members capable of boarding the vehicle c (hereinafter, referred to as a maximum number of passengers)
   In addition, the following values are input for each parking lot p E P.
A set of parking lots p.neighbors (⊆ P) neighboring to the parking lot p
a time period p.time (∈ N) required for moving from the parking lot p to a parking lot q (∈ p.neighbors) neighboring to the parking lot p
A number p.shortage (∈ N) of vehicles to be still accommodated in the parking lot p

### (2) Output

The output in the delivery planning problem is as follows.
A movement plan carPlan (c)=[(t_{c, 0}, p_{c, 0}), (t_{c, 1}, p_{c, 1}), . . . , (t_{c, n_c}, P_{c, n_c})] of the vehicle c for each vehicle c ∈ C,
   where (t_{c, i}, p_{c, i}) expresses that the vehicle c arrives at a parking lot p_{c, i} at a time t_{c, i}

Note that a departure time can be calculated from an arrival time at a destination, and thus, the departure time is not included in the movement plan carPlan (c).
A boarding plan staffPlan (s)=[(t_{s, 0}, p_{s, 0}), c_{s, 0}, (t_{c, 1}, p_{c, 1}), c_{s, 1}, . . . , c_{s, m_s-1}, (t_{c, m_s}, p_{c, m_s})] of the staff member s for each staff member s ∈ S,
   where (t_{s, j}, p_{s, j}) expresses that the staff members arrives at a parking lot p_{s, j} at a time t_{s, j}, and c_{s, j} represents a vehicle used for the movement.

Note that the departure time can be calculated from the arrival time at the destination, and thus, the departure time is not included in the boarding plan staffPlan (s).

It is assumed that the movement plan carPlan (c) of the vehicle c and the boarding plan staffPlan (s) of the staff member s satisfy the following conditions (a) to (j).
(a) Constraint on Vehicle Initial Position
   The constraint on a vehicle initial position is a condition that a delivery work starts from an input initial position of the vehicle.
(b) Constraint on Staff Initial Position
   The constraint on a staff initial position is a condition that a delivery work starts from an input initial position of the staff member.
(c) Constraint on Staff Return
   The constraint on staff return is a condition that a delivery work ends at an input initial position of the staff member.
(d) Constraint on Riding Vehicle
(e) Constraint on Exiting Vehicle
(f) Constraint on Transportation Means
(g) Constraint Dictating that Vehicle Moves to Neighboring Parking Lot
(h) Constraint on Vehicle Capacity
(i) Constraint Dictating That Parking Lot is Filled with Vehicles
(j) Optimization Condition

The optimization condition is a condition for minimizing the total of a staff cost and a vehicle cost incurred until the delivery end time Close. Here, the staff cost is defined as a cost generated while a staff member is at a position other than the initial position, and it is assumed that the staff member comes to the initial position for work and leaves work at the initial position. Note that, if the staff cost is defined as the cost generated while the staff member is at a position other than the initial position, the above-mentioned optimization condition is a condition for minimizing the total cost while allowing that (1) a staff member comes to work two or more times on the same day, and (2) a staff member does not come to work. This can be seen from the fact that in both cases (1) and (2), a time period during which the staff member is at the initial position is considered as a time period during which the staff member is not at work, and that in case (1), the staff member can be interpreted as moving two or more times from the initial position to a position other than the initial position and returning to the initial position, that is, coming to work two or more times and in case (2), the staff member can be interpreted as being at the initial position at all times, that is, being not at work. Furthermore, the vehicle cost is defined as a cost incurred while the vehicle is moving.

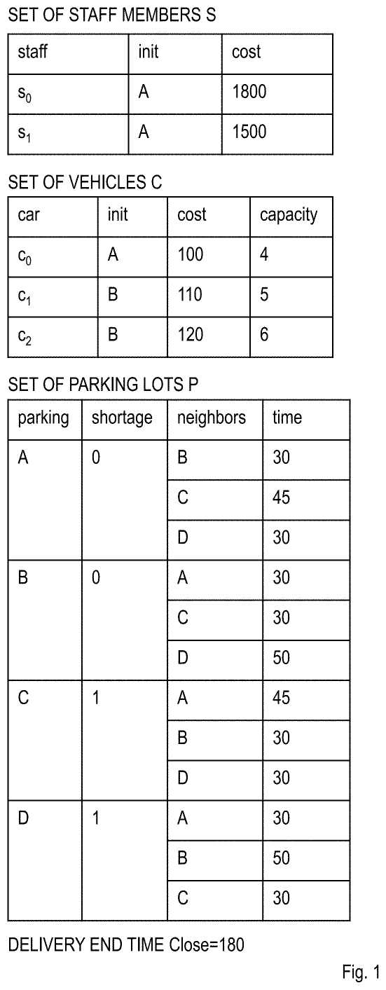

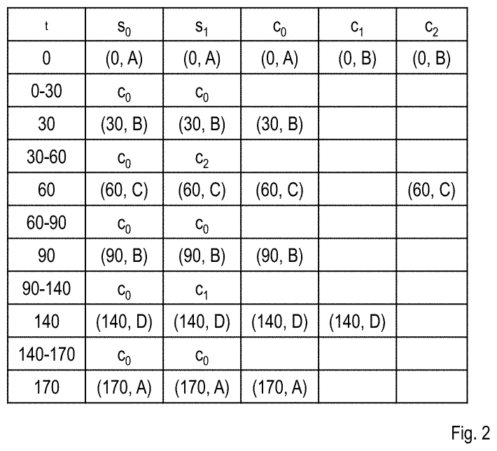

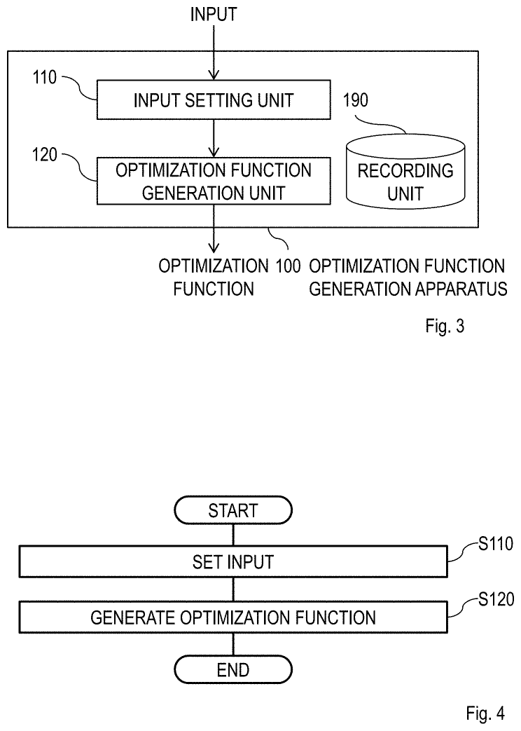

FIG. 1 is a table showing an example of an input in the delivery planning problem. FIG. 2 is a table showing an example of an output in the delivery planning problem. As seen from FIG. 1, the delivery planning problem is a problem that two staff members s₀ and s₁ start a delivery work from a parking lot A, deliver one vehicle to be still accommodated in a parking lot C and one vehicle to be still accommodated in a parking lot D to the parking lot C and the parking lot D, respectively, and then, the staff members s₀ and s₁ return to the parking lot A until a delivery end time 180. FIG. 2 represents such delivery plan in a table. In the table of FIG. 2, columns for the staff members indicate a parking lot or a vehicle with each of the staff members being present at each time. Furthermore, columns for the vehicles indicate, at a time when a value is entered into the column, a parking lot with a vehicle at the time, and at a time when the column is blank, indicate that a vehicle is moving at the time.

Quantum bits used to solve the delivery planning problem will be described. Here, the quantum bits are variables expressing quantum states having a value of 1 or 0. In the delivery planning problem according to the present invention, six types of quantum bits, carStop_{t, c, p}, carMove_{t, c}, staffStop_{t, s, p}, staffMove_{t, s}, ride_{t, s, c}, and noRide_{t, s}, are defined and used as described below.
(a) carStop_{t, c, p}: is defined as “1” if the vehicle c is in the parking lot pat a time t, and otherwise, as “0”, where 0≤t ≤Close. carStop_{0, c, c.init} is defined as a constant “1”, and carStop_{0, c, p} (p≠c.init) is defined as a constant “0”. Furthermore, if t>Close, carStop_{t, c, p} is defined as a constant “0”.

With these definitions, the constraint on the vehicle initial position is satisfied. (b) carMove_{t, c}: is defined as “1” if the vehicle c is moving at the time t, and otherwise, as “0”, where 0≤t≤Close. Furthermore, if t>Close, carMove_{t, c} is defined as a constant “1”.

(c) staffStop_{t, s, p}: is defined as “1” if the staff member s is in the parking lot p at the time t, and otherwise, as “0”, where 0≤t≤Close. staffStop_{0, s, s.init} and staffStop_{Close, s, s.init} are defined as constants “1”, and staffStop_{0, s, p} (p≠s.init) and staffStop_{Close, s, p} (p≠s.init) are defined as constants “0”.

With these definitions, the constraint on the staff initial position and the constraint on the staff return are satisfied.
(d) staffMove_{t, s}: is defined as “1” if the staff members is moving at the time t, and otherwise, as “0”, where 0≤t<Close.
(e) ride_{t, s, c}: is defined as “1” if the staff members is in the vehicle c from the time t to a time t+1, and otherwise, as “0”, where 0≤t<Close.
(f) noRide_{t, s}: is defined as “1” if the staff members is not in any vehicle from the time t to the time t+1, and otherwise, as “0”, where 0≤t<Close.

Note that, if the symbol of equivalence <=> is used, the definitions of the quantum bits carStop_{t, c, p}, carMove_{t, c}, staffStop_{t, s, p}, staffMove_{t, s}, ride_{t, s, c}, and noRide_{t, s} may be expressed as follows.
(a) carStop_{t, c, p}=1 <=> “the vehicle c is in the parking lot p at the time t”
(b) carMove_{t, c}=1 <=> “the vehicle c is moving at the time t”
(c) staffStop_{t, s, p}=1 <=> “the staff member s is in the parking lot p at the time t”
(d) staffMove_{t, s}=1 <=> “the staff member s is moving at the time t”
(e) ride_{t, s, c}=1 <=> “the staff member s is in the vehicle c from the time t to the time t+1”
(f) noRide_{t, s}=1 <=> “the staff member s is not in any vehicle from the time t to the time t+1”

Based on the above, a QUBO objective function will be described below. Here, it is assumed that an expression representing a certain constraint indicates a state where the constraint is satisfied when the value of the expression is 0, and indicates a state where the constraint is not satisfied when the value of the expression is a value greater than 0.

A QUBO objective function CarSharing can be defined according to the following equation.

$$[ Math . 1 ]$$

$$CarSharing = Penalty * Restriction + Cost \qquad ( 1 )$$

$$Restriction = CarSemantics + StaffSemantics + RideSemantics + MoveSemantics + GetOn + GetOff + OnlyCar + Neighbor + Capacity + Fulfill \qquad ( 2 )$$

where Restriction is an expression representing a condition other than a minimization condition, Cost is an expression representing the minimization condition, and Penalty is a constant representing a weight of the expression Restriction. In addition, CarSemantics is an expression representing a constraint on defining the meaning of the quantum bits carStop_{t, c, p} and carMove_{t, c}, StaffSemantics is an expression representing a constraint on defining the meaning of the quantum bits staffStop_{t, s, p} and staffMove_{t, s}, rideSemantics is an expression representing a constraint on defining the meaning of the quantum bits ride_{t, s, c} and noRide_{t, s}, and moveSemantics is an expression representing a constraint on defining the meaning of the quantum bits ride_{t, s, c}, carMove_{t, c}, and staffMove_{t, s}. Furthermore, GetOn is an expression representing the constraint on riding a vehicle, GetOff is an expression representing the constraint on exiting a vehicle, OnlyCar is an expression representing the constraint on the transportation means, Neighbor is an expression representing the constraint dictating that the vehicle moves to a neighboring parking lot, Capacity is an expression representing the constraint on the vehicle capacity, and Fulfill is an expression representing the constraint dictating that a parking lot is filled with vehicles.

A value of Penalty may be 10000, for example. If the value of Penalty is much larger than a value that the expression Cost representing the minimization condition may take, the QUBO objective function CarSharing is tuned so as to preferentially satisfy the expression Restriction.

The expression CarSemantics is an expression representing a constraint that “at the time t, the vehicle c is in any one parking lot of the set of parking lots P or is moving”.

$$[ Math . 2 ]$$

$$CarSemantics = {\sum }_{0 \leq t \leq Close} {\sum }_{c ∈ C} {( ( {\sum }_{p ∈ P} {carStop}_{t , c , p} ) + {carMove}_{t , c} - 1 )}^{2} \qquad ( 3 )$$

Equation (3) will be described. If only one quantum bit of the quantum bits carStop_{t, c, p} (p ∈ P) and carMove_{t, c} is “1”, the expression ((ΣₚcarStop_{t, c, p})+carMove_{t, c}−1)² is “0”. Consequently, the expression CarSemantics represents the constraint that “at the time t, the vehicle c is in any one parking lot of the set of parking lots P or is moving”.

The expression StaffSemantics is an expression representing a constraint that “at the time t, the staff member s is in any one parking lot of the set of parking lots P or is moving”.

$$[ Math . 3 ]$$

$$StaffSemantics = {\sum }_{0 \leq t \leq Close} {\sum }_{s ∈ S} {( ( {\sum }_{p ∈ P} {staffStop}_{t , s , p} ) + {staffMove}_{t , s} - 1 )}^{2} \qquad ( 4 )$$

Equation (4) will be described. If only one quantum bit of the quantum bits staffStop_{t, s, p} (p ∈ P) and staffMove_{t, s} is “1”, the expression ((ΣₚstaffStop_{t, s, p})+staffMove_{t, s}−1)² is “0”. Consequently, the expression StaffSemantics represents the constraint that “at the time t, the staff member s is in any one parking lot of the set of parking lots P or is moving”.

The expression RideSemantics is an expression representing a constraint that “at the time t, the staff members is in any one vehicle of the set of vehicles C or is not in any vehicle”.

$$[ Math . 4 ]$$

$$RideSemantics = {\sum }_{0 \leq t < Close} {\sum }_{s ∈ S} {( ( {\sum }_{c ∈ C} {ride}_{t , s , c} ) + {noRide}_{t , s} - 1 )}^{2} \qquad ( 5 )$$

Equation (5) will be described. If only one quantum bit of the quantum bits ride_{t, s, c} (c ∈ C) and noRide_{t, s} is “1”, the expression ((Σ_{c}ride_{t, s, c})+noRide_{t, s}−1)² is “0”. Consequently, the expression RideSemantics represents the constraint that “at the time t, the staff member s is in any one vehicle of the set of vehicles C or is not in any vehicle”.

The expression MoveSemantics is an expression representing a constraint that “when the staff member s is in the vehicle c from the time t to the time t+1, whether the staff member s is moving and whether the vehicle c is moving, match at the time t”.

$$[ Math . 5 ]$$

$$MoveSemantics = {\sum }_{0 \leq t < Close} {\sum }_{s ∈ S} {\sum }_{c ∈ C} ( {ride}_{t , s , c} * {( {carMove}_{t , c} - {staffMove}_{t , s} )}^{2} ) \qquad ( 6 )$$

Equation (6) will be described. If the quantum bit ride_{t, s, c} is “0” or if carMove_{t, c}=staffMove_{t, s}, the expression (ride_{t, s, c}*(carMove_{t, c}−staffMove_{t, s})²) is “0”. Consequently, if the quantum bit ride_{t, s, c} is “1” and carMove_{t, c}=staffMove_{t, s}, the expression (ride_{t, s, c}*(carMove_{t, c}−staffMove_{t, s})²) is “0”. Thus, the expression MoveSemantics represents the constraint that “when the staff member s is in the vehicle c from the time t to the time t+1, whether the staff member s is moving and whether the vehicle c is moving, match at the time t”.

Note that Equation (6) is a cubic equation, and thus, in order to process Equation (6) as a QUBO allowing only a quadratic equation, it is necessary to perform processing for reducing the order. For this order reduction processing, for example, the method described in Reference NPL 1 may be employed.

(Reference NPL 1: Nike Dattani, “Quadratization in Discrete Optimization and Quantum Mechanics”, [online], [searched on Feb. 12, 2020], Internet <URL: https://arxiv.org/pdf/1901.04405.pdf>)

The expression GetOn is an expression representing the constraint on riding a vehicle.

$$[ Math . 6 ]$$

$$GetOn = {\sum }_{0 \leq t < Close} {\sum }_{s ∈ S} {\sum }_{c ∈ C} {\sum }_{p ∈ P} ( {ride}_{t , s , c} * {( {carStop}_{t , c , p} - {staffStop}_{t , s , p} )}^{2} ) \qquad ( 7 )$$

Equation (7) will be described. If the quantum bit ride_{t, s, c} is “0” or if carStop_{t, c, p}=staffStop_{t, s, p}, the expression (ride_{t, s, c}*(carStop_{t, c, p}−staffStop_{t, s, p})²) is “0”. Consequently, if the quantum bit ride_{t, s, c} is “1” and carStop_{t, c, p}=staffStop_{t, s, p}, the expression (ride_{t, s, c}*(carStop_{t, c, p} staffStop_{t, s, p})²) is “0”. Thus, the expression GetOn represents the constraint on riding a vehicle.

Note that Equation (7) is a cubic equation, and thus, it is necessary to perform processing for reducing the order, similarly to Equation (6).

The expression GetOff is an expression representing the constraint on exiting a vehicle.

$$[ Math . 7 ]$$

$$GetOff = {\sum }_{0 \leq t < Close} {\sum }_{s ∈ S} {\sum }_{c ∈ C} {\sum }_{p ∈ P} ( {ride}_{t , s , c} * {( {carStop}_{t + 1 , c , p} - {staffStop}_{t + 1 , s , p} )}^{2} ) \qquad ( 8 )$$

Equation (8) will be described. If the quantum bit ride_{t, s, c} is “0” or if carStop_{t+1, c, p}=staffStop_{t+1, s, p}, the expression (ride_{t, s, c}*(carStop_{t+1, c, p}−staffStop_{t+1, s, p)}²) is “0”. Consequently, if the quantum bit ride_{t, s, c} is “1” and carStop_{t+1, c, p}=staffStop_{t+1, s, p}, the expression (ride_{t, s, c}*(carStop_{t+1, c, p} staffStop_{t+1, s, p)}²) is “0”. Thus, the expression GetOff represents the constraint on exiting a vehicle.

Note that Equation (8) is a cubic equation, and thus, it is necessary to perform processing for reducing the order, similarly to Equation (6).

The expression OnlyCar is an expression representing the constraint on the transportation means.

$$[ Math . 8 ]$$

$$OnlyCar = {\sum }_{0 \leq t < Close} {\sum }_{s ∈ S} {\sum }_{p ∈ P} ( {noRide}_{t , s} * {( {staffStop}_{t , s , p} - {staffStop}_{t + 1 , s , p} )}^{2} ) \qquad ( 9 )$$

Equation (9) will be described. If the quantum bit noRide_{t, s} is “0” or if staffStop_{t, s, p}=staffStop_{t+1, s, p}, the expression (noRide_{t, s}*(staffStop_{t, s, p}−staffStop_{t+1, s, p})²) is “0”. Consequently, if the quantum bit noRide_{t, s} is “1” and staffStop_{t, s, p}=staffStop_{t+1, s, p}, the expression (noRide_{t, s}*(staffStop_{t, s, p} staffStop_{t+1, s, p)}²) is “0”. Thus, the expression OnlyCar represents the constraint on the transportation means.

Note that Equation (9) is a cubic equation, and thus, it is necessary to perform processing for reducing the order, similarly to Equation (6).

The expression Neighbor is an expression representing the constraint dictating that the vehicle moves to a neighboring parking lot.

$$[ Math . 9 ]$$

$$Neighbor = {\sum }_{0 \leq t < Close} {\sum }_{c ∈ C} {\sum }_{p ∈ P} Choice ( t , c , p , {carStop}_{t , c , p} ) \qquad ( 10 )$$

$$Choice ( t , c , p , bind ) = {( {\sum }_{q ∈ p . neighbors} {goto}_{t , c , p , q} + {wait}_{t , c , p} - bind )}^{2} + {\sum }_{q ∈ p . neighbors} Goto ( t , c , p , q , {goto}_{t , c , p , q} ) + Wait ( t , c , p , {wait}_{t , c , p} ) \qquad ( 11 )$$

$$Goto ( t , c , p , q , bind ) = bind * ( p . time ( q ) - ( {\sum }_{1 \leq i < p . time ( q )} {carMove}_{t + i , c} + {carStop}_{t + p . time ( q ) , c , q} ) ) \qquad ( 12 )$$

$$Wait ( t , c , p , bind ) = bind * ( 1 - {carStop}_{t + 1 , c , p} ) \qquad ( 13 )$$

Here, the expression Choice (t, c, p, bind) is an expression representing a constraint that, “regarding the time t, the vehicle c, the parking lot p, and the quantum bit bind, if ‘bind=1’, ‘the vehicle c either moves to the parking lot q neighboring to the parking lot p during a time period p.time (q) from the time t+1, or the vehicle c does not move and is in the parking lot p even at the time t+1’”. The expression Goto (t, c, p, q, bind) is an expression representing a constraint that “regarding the time t, the vehicle c, the parking lot p, the parking lot q neighboring to the parking lot p, and the quantum bit bind, if ‘bind=1’, ‘the vehicle c is moving from the time t+1 to a time t+p.time (q)−1, and the vehicle c is in the parking lot q at a time t+p.time (q)’”. The expression Wait (t, c, p, bind) is an expression representing a constraint that “regarding the time t, the vehicle c, the parking lot p, and the quantum bit bind, if ‘bind=1’, ‘the vehicle c is in the parking lot p at the time t+1’”. Note that in each of the expression Choice (t, c, p, bind), the expression Goto (t, c, p, q, bind), and the expression Wait (t, c, p, bind), if “bind=0”, values of the expressions constituting these expressions may take any value.

In order to explain Equation (10), Equations (13), (12), and (11) included in Equation (10) will be described in this order.

Equation (13) will be described. If the quantum bit bind is “0” or if carStop_{t+1, c, p}=1, the expression bind*(1−carStop_{t+1, c, p}) is “0”. Consequently, if the quantum bit bind is “1” and carStop_{t+1, c, p}=1, the expression bind*(1−carStop_{t+1, c, p}) is “0”. Thus, the expression Wait (t, c, p, bind) represents the constraint that “regarding the time t, the vehicle c, the parking lot p, and the quantum bit bind, if ‘bind=1’, ‘the vehicle c is in the parking lot p at the time t+1’”.

Equation (12) will be described. If both carMove_{t+i, c} (1≤i<p.time (q)) and carStop_{t+p.time (q), c, q} are “1”, the expression (p.time (q)−ΣᵢcarMove_{t+i, c}+carStop_{t+p.time (q), c, q)} is “0”. That is, if “the vehicle c is moving from the time t+1 to the time t+p.time (q)−1 and the vehicle c is in the parking lot q at the time t+p.time (q)”, the expression (p.time (q)−ΣᵢcarMove_{t+i, c}+carStop_{t+p.time (q), c, q}) is “0”. Consequently, the expression bind*(p.time (q)−Σᵢ carMove_{t+i, c}+carStop_{t+p.time (q), c, q}) is “0”, if the quantum bit bind is “0”, or if “the vehicle c is moving from the time t+1 to the time t+p.time (q)−1 and the vehicle c is in the parking lot q at the time t+p.time (q)”. That is, if the quantum bit bind is “1” and “the vehicle c is moving from the time t+1 to the time t+p.time (q)−1 and the vehicle c is in the parking lot q at the time t+p.time (q)”, the expression bind*(p.time (q)−ΣᵢcarMove_{t+i, c}+carStop_{t+p.time (q), c, q}) is “0”. Thus, the expression Goto (t, c, p, q, bind) represents the constraint that “regarding the time t, the vehicle c, the parking lot p, the parking lot q neighboring to the parking lot p, and the quantum bit bind, if ‘bind=1’, ‘the vehicle c is moving from the time t+1 to the time t+p.time (q)−1, and the vehicle c is in the parking lot q at the time t+p.time (q)’”.

Equation (11) will be described. In the expression Σ_{q}goto_{t, c, p, q}+wait_{t, c, p}−bind, if “bind=1”, any one of the quantum bits goto_{t, c, p, q} (q ∈ p.neighbors) and wait_{t, c, p} is “1”. In the expression Goto (t, c, p, q, goto_{t, c, p, q}), if the quantum bit goto_{t, c, p, q} is “1”, “the vehicle c moves to the parking lot q neighboring to the parking lot p during the time period p.time (q) from the time t+1”. In the expression Wait (t, c, p, wait_{t, c, p}), if the quantum bit wait_{t, c, p} is “1”, “the vehicle c does not move and is in the parking lot p even at the time t+1”. Thus, in the expression Choice (t, c, p, bind), if “bind=1”, “the vehicle c moves to the parking lot q neighboring to the parking lot p during the time period p.time (q) from the time t+1” or “the vehicle c does not move and is in the parking lot p even at the time t+1”. Consequently, the expression Choice (t, c, p, bind) represents the constraint that, “regarding the time t, the vehicle c, the parking lot p, and the quantum bit bind, if ‘bind=1’, ‘the vehicle c either moves to the parking lot q neighboring to the parking lot p during the time period p.time (q) from the time t+1, or the vehicle c does not move and is in the parking lot p even at the time t+1’”.

Equation (10) will be described. In the expression Choice (t, c, p, carStop_{t, c, p}), if “carStop_{t, c, p}=1”, “the vehicle c either moves to the parking lot q neighboring to the parking lot p during the time period p.time (q) from the time t+1 or the vehicle c does not move and is in the parking lot p even at the time t+1”. That is, when “the vehicle c is in the parking lot p at the time t”, “the vehicle c either moves to the parking lot q neighboring to the parking lot p during the time period p.time (q) from the time t+1 or the vehicle c does not move and is in the parking lot p even at the time t+1”. Thus, the expression Neighbor represents the constraint dictating that the vehicle moves to a neighboring parking lot.

The expression Capacity is an expression representing the constraint on the vehicle capacity.

$$[ Math 10 ]$$

$$Capacity = {\sum }_{0 \leq t < Close} {\sum }_{c ∈ C} PartialCapacity ( t , c ) \qquad ( 14 )$$

$$PartialCapacity ( t , c ) = {( {\sum }_{s ∈ S} {ride}_{t , s , c} - {\sum }_{0 \leq i < m i n ( c . capacity \vert S \vert )} {cCount}_{t , c , i} )}^{2} + {\sum }_{0 < i < m i n ( c . capacity , \vert S \vert )} ( 1 - {cCount}_{t , c , 0} ) * {cCount}_{t , c , i} + ( {carMove}_{t , c} + {\sum }_{p ∈ P} {\sum }_{q ∈ p . neighbor} {goto}_{t , c , p , q} ) * ( 1 - {cCount}_{t , c , 0} ) \qquad ( 15 )$$

Equation (14) will be described. If the number of quantum bits having a value of “1” among quantum bits cCount_{t, c, 0}, . . . , cCount_{t, c, min (c.capacity, |S|)-1} is equal to the number of staff members in the vehicle c from the time t to the time t+1, the expression (Σₛride_{t, s, c}−ΣᵢcCount_{t, c, i})² is “0”. Note that Σₛride_{t, s, c} is not greater than the maximum number of passengers c.capacity of the vehicle c. Furthermore, the expression (1−cCount_{t, c, l})*cCount_{t, c, i} expresses that the quantum bit cCount_{t, c, 0} is preferentially “1”, compared to other quantum bits cCount_{t, c, i}. Consequently, Σₛride_{t, s, c}≤1 <=> cCount_{t, c, 0}=1 is obtained. Here, if (carMove_{t, c}+ΣₚΣ_{q}goto_{t, c, p, q})=1 (that is, when the vehicle c moves at the time t), the expression (carMove_{t, c}+ΣₚΣ_{q}goto_{t, c, p, q})*(1−cCount_{t, c, 0}) expresses that cCount_{t, c, 0}=1 is obtained, and thus, expresses that the number of staff members in the vehicle c is one or greater. Thus, the expression Capacity represents the constraint on the vehicle capacity.

The expression Fulfill is an expression representing the constraint dictating that a parking lot is filled with vehicles.

$$[ Math . 11 ]$$

$$Fulfill = {\sum }_{\begin{matrix}p ∈ P \\ p . short age > 0\end{matrix}} PartialFulfill ( p ) \qquad ( 16 )$$

$$PartialFulfill ( p ) = {( {\sum }_{c ∈ C} {carStop}_{Close , c , p} - {\sum }_{0 \leq i < \vert C \vert} {fCount}_{p , i} )}^{2} + {\sum }_{0 \leq i < \vert C \vert - 1} ( i + 1 ) * ( 1 - {fCount}_{p , i} ) * {fCount}_{p , i + 1} + ( 1 - {fCount}_{p , p . shortage - 1} ) \qquad ( 17 )$$

Equation (16) will be described. If the number of quantum bits having a value of “1” among quantum bits fCount_{p, 0}, . . . , fCount_{p, |C|-1} is equal to the number of vehicles in the parking lot p at the delivery end time Close, the expression (Σ_{C}carStop_{Close, c, p}−ΣᵢfCount_{p, i})² is “0”. If “the quantum bit fCount_{p, i} is ‘0’” and “the quantum bit fCount_{p, i+1} is ‘1’”, the expression (i+1)*(1−fCount_{p, i})*fCount_{p, i+1} violates the constraint. Consequently, when the number of vehicles in the parking lot p at the delivery end time Close is K, among the quantum bits fCount_{p, 0}, fCount_{p, |C|-1}, only K quantum bits from the quantum bit fCount_{p, 0} are “1”, that is, fCount_{p, 0}=1, . . . , fCount_{p, K-1}=1 and fCount_{p, K-}=0, . . . , fCount_{p, |C|-1}=0 are obtained. If “fCount_{p, p.shortage-1}=1”, the expression 1−fCount_{p, p.shortage-1} is “0”, and thus, the expression Fulfill represents the constraint dictating that a parking lot is filled with vehicles.

The expression Cost is an expression representing “a total of a staff cost and a vehicle cost incurred until the delivery end time Close”.

$$[ Math . 12 ]$$

$$Cost = StaffCost + CarCost \qquad ( 18 )$$

$$StaffCost = {\sum }_{0 \leq t < Close} {\sum }_{s ∈ S} ( s . cost * ( 1 - {staffStop}_{t , s , s . init} * {staffStop}_{t + 1 , s , s . init} ) ) \qquad ( 19 )$$

$$carCost = {\sum }_{0 \leq t < Close} {\sum }_{c ∈ C} ( c . cost * \qquad ( 20 )$$

$$( {\sum }_{p ∈ P} ( {carStop}_{t , c , p} * ( 1 - {carStop}_{t + 1 , c , p} ) ) + {carMove}_{t , c} ) )$$

Here, from the description for the optimization conditions above, the staff cost incurred until the delivery end time Close is calculated based on (a time period during which the staff member is not at the initial position) x s.cost.

Equation (19) will be described. If both quantum bits staffStop_{t, s, s.init} and staffStop_{t+1, s, s.init} are “1”, the expression s.cost*(1−staffStop_{t, s, s.init}*staffStop_{t+1, s, s.init) is “}0”, and otherwise, is “s.cost”. That is, if the staff member s is at the initial position from the time t to the time t+1, the expression s.cost*(1−staffStop_{t, s, s.init}*staffStop_{t+1, s, s.init}) is “0”, and otherwise, is “s.cost”. Consequently, Equation (19) expresses that a cost is generated for a time period during which the staff member is not at the initial position.

Equation (20) will be described. If the quantum bit carStop_{t, c, p} is “1” and the quantum bit carStop_{t+1, c, p} is “0”, or if the quantum bit carMove_{t, c} is “1”, the expression c.cost*(Σₚ(carStop_{t, c, p}*(1−carStop_{t+1, c, p})) carMove_{t, c}) is “c.cost” and otherwise, is “0”. Consequently, Equation (20) expresses that a cost is generated for a time period during which the vehicle is moving.

Thus, the expression Cost represents “the total of a staff cost and a vehicle cost incurred until the delivery end time Close”.

As described above, the six types of quantum bits carStop_{t, c, p}, carMove_{t, c}, staffStop_{t, s, p}, staffMove_{t, s}, ride_{t, s, c}, and noRide_{t, s}, which are variables representing a certain state by 1 and another state by 0, are used to define CarSemantics of Equation (3), StaffSemantics of Equation (4), RideSemantics of Equation (5), MoveSemantics of Equation (6), GetOn of Equation (7), GetOff of Equation (8), OnlyCar of Equation (9), Neighbor of Equation (11), Capacity of Equation (14), and Fulfill of Equation (16) as functions having a value of 0 if constraints represented by each expression are satisfied, and a value greater than 0, otherwise, and Cost of Equation (18) is defined as a function in which a value is smaller as the total of a staff cost and a vehicle cost incurred until the delivery end time Close is smaller. Thus, the QUBO objective function CarSharing is a function designed to have a minimum value when all constraints including the constraint represented by the expression CarSemantics, the constraint represented by the expression StaffSemantics, the constraint represented by the expression RideSemantics, the constraint represented by the expression MoveSemantics, the constraint represented by the expression GetOn, the constraint represented by the expression GetOff, the constraint represented by the expression OnlyCar, the constraint represented by the expression Neighbor, the constraint represented by the expression Capacity, and the constraint represented by the expression Fulfill are satisfied and the expression Cost takes a minimum value. Thus, the QUBO objective function CarSharing is a function in which a solution can be achieved by a quantum annealing machine or an Ising machine.

### FIRST EMBODIMENT

An optimization function generation apparatus 100 generates an optimization function for variables representing quantum states for solving a delivery planning problem. Here, the delivery planning problem is a problem that, under predetermined constraint conditions, a plan is generated for delivering a vehicle to a parking lot short of vehicles to be parked, so that a condition for minimizing a total of a staff cost and a vehicle cost incurred until the delivery end time Close (hereinafter, referred to as an optimization condition) is satisfied. Furthermore, the predetermined constraint conditions include a constraint on riding a vehicle, that is, a condition that, when a staff member s ∈ S is in a vehicle c ∈ C from the time t to the time t+1, a parking lot with the staff member s being present and a parking lot with the vehicle c being present at the time t coincide (hereinafter, referred to as a first constraint condition), a constraint on exiting a vehicle, that is, a condition that, when the staff member s ∈ S is in the vehicle c ∈ C from the time t to the time t+1, a parking lot with the staff member s being present and a parking lot with the vehicle c being present at the time t+1 coincide (hereinafter, referred to as a second constraint condition), a constraint on the transportation means, that is, a condition that, when the staff member s ∈ S is not in a vehicle from the time t to the time t+1, a parking lot with the staff member s being present at the time t and a parking lot with the staff member s being present at the time t+1 coincide (hereinafter, referred to as a third constraint condition), a constraint dictating that the vehicle moves to a neighboring parking lot, that is, a condition that, when the vehicle c ∈ C is in the parking lot p ∈ P at the time t, the vehicle c either moves to the parking lot q ∈ p.neighbors neighboring to the parking lot p during the time period p.time (q) or the vehicle c does not move and is present in the parking lot p even at the time t+1 (hereinafter, referred to as a fourth constraint condition), a constraint on the vehicle capacity, that is, a condition that one to c.capacity staff members are needed for delivering the vehicle c ∈ C (hereinafter, referred to as a fifth constraint condition), and a constraint dictating that a parking lot is filled with vehicles, that is, a condition that p.shortage or greater vehicles are present in the parking lot p ∈ P at the delivery end time Close (hereinafter, referred to as a sixth constraint condition) as described in the Technical Background. In addition, here, quantum bits indicating a certain state by 1 and another state by 0 are employed for variables representing quantum states. Specifically, the quantum bit carStop_{t, c, p} defined so as to express a state where the vehicle c is in the parking lot p at the time t by a value of 1, and another state by a value of 0, the quantum bit carMove_{t, c} defined so as to express a state where the vehicle c is moving at the time t by a value of 1, and another state by a value of 0, the quantum bit staffStop_{t, s, p} defined so as to express a state where the staff member s is in the parking lot p at the time t by a value of 1, and another state by a value of 0, the quantum bit staffMove_{t, s} defined so as to express a state where the staff member s is moving at the time t by a value of 1, and another state by a value of 0, the quantum bit ride_{r, s, c} defined so as to express a state where the staff member s is in the vehicle c from the time t to the time t+1 by a value of 1, and another state by a value of 0, and the quantum bit noRide_{t, s} defined so as to express a state where the staff member s is not in any vehicle from the time t to the time t+1 by a value of 1, and another state by a value of 0, are used.

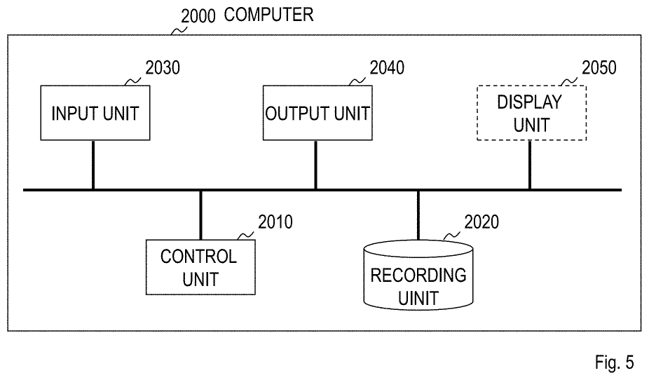

The optimization function generation apparatus 100 will be described below with reference to FIGS. 5 and 6. FIG. 5 is a block diagram illustrating a configuration of the optimization function generation apparatus 100. FIG. 6 is a flowchart illustrating an operation of the optimization function generation apparatus 100. As illustrated in FIG. 5, the optimization function generation apparatus 100 includes an input setting unit 110, an optimization function generation unit 120, and a recording unit 190. The recording unit 190 is a constituent component that appropriately records information necessary for processing by the optimization function generation apparatus 100.

An operation of the optimization function generation apparatus 100 will be described with reference to FIG. 6.

In S110, the input setting unit 110 inputs the set of staff members S, the set of vehicles C, the set of parking lots P, the delivery end time Close, the parking lot s.init (∈ P) with the staff member s (∈ S) being present at the delivery start time, the cost s.cost for the staff member s per unit time, the parking lot c.init (∈ P) with the vehicle c (∈ C) being present at the delivery start time, the cost c.cost for the vehicle c per unit time, the maximum value c.capacity of staff members capable of boarding the vehicle c, the set of parking lots p.neighbors (⊆ P) neighboring to the parking lot p (∈ P), the time period p.time (q) required for moving from the parking lot p to the parking lot q (∈ p.neighbors) neighboring to the parking lot p, and the number p.shortage of vehicles to be still accommodated in the parking lot p and sets these pieces of data as input for the delivery planning problem.

In S120, the optimization function generation unit 120 receives the input for the delivery planning problem set in S110 as input, and uses this input to generate and output an optimization function for solving the delivery planning problem. Here, the optimization function is a function defined by using the quantum bits carStop_{t, c, p}, carMove_{t, c}, staffStop_{t, s, p}, staffMove_{t, s}, ride_{t, s, c}, and noRide_{t, s}, and specifically, is a QUBO objective function defined on the basis of functions expressing the meaning of four quantum bits, functions expressing six constraint conditions, and a function expressing an optimization condition.

The QUBO objective function is the function CarSharing of Equation (1). Furthermore, the functions expressing the meaning of the four quantum bits are the function CarSemantics of Equation (3), the function StaffSemantics of Equation (4), the function RideSemantics of Equation (5), and the function MoveSemantics of Equation (6). The functions expressing the six constraint conditions are the function GetOn of Equation (7), the function GetOff of Equation (8), the function OnlyCar of Equation (9), the function Neighbor of Equation (10), the function Capacity of Equation (14), and the function Fulfill of Equation (16). The function expressing the optimization condition is the function Cost of Equation (18).

The functions CarSemantics, StaffSemantics, RideSemantics, and MoveSemantics expressing the meaning of the quantum bits are functions defined so that values thereof are smallest when the meaning of each of the quantum bits is correctly expressed, and more specifically, are functions having a value of 0 when the meaning of the quantum bit is correctly expressed, and otherwise, a value greater than 0. In addition, the functions GetOn, GetOff, OnlyCar, Neighbor, Capacity, and Fulfill expressing the constraint conditions are functions defined so that a value thereof is smallest when the corresponding constraint conditions are satisfied, and more specifically, are functions having a value of 0 when the constraint conditions are satisfied, and otherwise, a value greater than 0. Furthermore, the function Cost representing the optimization condition is a function defined so that a value thereof is smaller when the total of the staff cost and the vehicle cost incurred until the delivery end time Close is smaller.

Consequently, the QUBO objective function CarSharing, which is an optimization function, is a function designed to have a minimum value only when all of the first to sixth constraint conditions are satisfied.

Note that the QUBO objective function CarSharing is defined as the weighted sum of the function Restriction of Equation (2) and the function Cost expressing the optimization condition. If the weight, Penalty has a value greater than a value that the function Cost may take, it is possible to tune the objective function CarSharing so as to prioritize correct expression of the meaning of the six quantum bits and satisfaction of the six constraints.

### MODIFIED EXAMPLE

Instead of using the QUBO objective function using quantum bits, an Ising Hamiltonian using spins may be employed for the optimization function. Here, the spins are variables expressing quantum states and having values of 1 or −1. Conversion between a spin s and a quantum bit x is possible by Equations (21) and (22).

$$[ Math . 13 ]$$

$$x = \frac{s + 1}{2} \qquad ( 21 )$$

$$s = 2 x - 1 \qquad ( 22 )$$

That is, when the quantum bit has a value of 1, the value of the spin is 1, and when the quantum bit has a value of 0, the value of the spin is −1.

Below, spins representing a certain state by 1 and another state by −1 are employed for variables representing quantum states. Specifically, a spin ˜carStop_{t, c, p} defined so as to express a state where the vehicle c is in the parking lot p at the time t by a value of 1, and another state by a value of −1, a spin ˜carMove_{t, c} defined so as to express a state where the vehicle c is moving at the time t by a value of 1, and another state by a value of −1, a spin ˜staffStop_{t, s, p} defined so as to express a state where the staff member s is in the parking lot p at the time t by a value of 1, and another state by a value of −1, a spin ˜staffMove_{t, s} defined so as to express a state where the staff member s is moving at the time t by a value of 1, and another state by a value of −1, a spin ˜ride_{t, s, c} defined so as to express a state where the staff member s is in the vehicle c from the time t to the time t+1 by a value of 1, and another state by a value of −1, and a spin ˜noRide_{t, s} defined so as to express a state where the staff member s is not in any vehicle from the time t to the time t+1 by a value of 1, and another state by a value of −1, are used. In this case, the optimization function is a function defined by using the spins ˜carStop_{t, c, p}, ˜carMove_{t, c}, ˜staffStop_{t, s, p}, ˜staffMove_{t, s}, ˜ride_{t, s, c}, and ˜noRide_{t, s}, and specifically, is an Ising Hamiltonian defined on the basis of functions expressing the meaning of four spins, functions expressing the six constraint conditions, and a function expressing an optimization condition.

The Ising Hamiltonian is a function obtained by applying the conversion of the variables as described above to the function CarSharing of Equation (1). Furthermore, the functions expressing the meaning of the four spins are a function obtained by applying the conversion of the variables as described above to the function CarSemantics of Equation (3), a function obtained by applying the conversion of the variables as described above to the function StaffSemantics of Equation (4), a function obtained by applying the conversion of the variables as described above to the function RideSemantics of Equation (5), and a function obtained by applying the conversion of the variables as described above to the function MoveSemantics of Equation (6). The functions expressing the six constraint conditions are a function obtained by applying the conversion of the variables as described above to the function GetOn of Equation (7), a function obtained by applying the conversion of the variables as described above to the function GetOff of Equation (8), a function obtained by applying the conversion of the variables as described above to the function OnlyCar of Equation (9), a function obtained by applying the conversion of the variables as described above to the function Neighbor of Equation (10), a function obtained by applying the conversion of the variables as described above to the function Capacity of Equation (14), and a function obtained by applying the conversion of the variables as described above to the function Fulfill of Equation (16). The function expressing the optimization condition is a function obtained by applying the conversion of the variables as described above to the function Cost of Equation (18).

The functions CarSemantics, StaffSemantics, RideSemantics, and MoveSemantics expressing the meaning of the spins are functions defined so that values thereof are smallest when the meaning of each of the spins is correctly expressed, and more specifically, are functions having a value of 0 when the meaning of the spins is correctly expressed, and otherwise, a value greater than 0. In addition, the functions GetOn, GetOff, OnlyCar, Neighbor, Capacity, and Fulfill expressing the constraint conditions are functions defined so that a value thereof is smallest when the corresponding constraint conditions are satisfied, and more specifically, are functions having a value of 0 when the constraint conditions are satisfied, and otherwise, a value greater than 0. Furthermore, the function representing the optimization condition is a function defined so that a value thereof is smaller as the total of the staff cost and the vehicle cost incurred until the delivery end time Close is smaller.

Consequently, the Ising Hamiltonian, which is an optimization function, is a function designed to have a minimum value only when all of the first to sixth constraint conditions are satisfied.

The optimization function output by the optimization function generation apparatus 100 is input to a quantum annealing machine or an Ising machine, for example, and if the optimization function is processed by these machines, it is possible to solve the delivery planning problem.

According to the embodiment of the present invention, it is possible to generate an optimization function for variables representing quantum states for solving a delivery planning problem with predetermined constraint conditions.

### <Supplements>

FIG. 5 is a diagram illustrating an example of a functional configuration of a computer achieving each apparatus described above. The processing in each of the above-described apparatuses can be performed by causing a recording unit 2020 to read a program for causing a computer to function as each of the above-described apparatuses, and operating the program in a control unit 2010, an input unit 2030, an output unit 2040, and the like.

The apparatus according to the present invention includes, for example, as single hardware entities, an input unit to which a keyboard or the like can be connected, an output unit to which a liquid crystal display or the like can be connected, a communication unit to which a communication apparatus (for example, a communication cable) capable of communication with the outside of the hardware entity can be connected, a CPU (Central Processing Unit, which may include a cache memory, a register, and the like), a RAM or a ROM that is a memory, an external storage apparatus that is a hard disk, and a bus connected for data exchange with the input unit, the output unit, the communication unit, the CPU, the RAM, the ROM, and the external storage apparatuses. An apparatus (drive) capable of reading and writing from and to a recording medium such as a CD-ROM may be provided in the hardware entity as necessary. An example of a physical entity including such hardware resources is a general-purpose computer.

A program necessary to implement the above-described functions, data necessary for processing of this program, and the like are stored in the external storage apparatus of the hardware entity (for example, the program may be stored not only in the external storage apparatus but in a ROM that is a read-only storage apparatus). For example, data obtained by the processing of the program is appropriately stored in a RAM, the external storage apparatus, or the like.

In the hardware entity, each program and data necessary for the processing of each program stored in the external storage apparatus (or a ROM, for example) are read into a memory as necessary and appropriately interpreted, executed, or processed by a CPU. As a result, the CPU achieves a predetermined function (each of the constituent components expressed as the above-described, unit, means, or the like).

The present invention is not limited to the above-described embodiment, and appropriate changes can be made without departing from the spirit of the present invention. The processing described in the embodiments is not only executed in time series in the described order, but also may be executed in parallel or individually according to a processing capability of an apparatus that executes the processing or as necessary.

As described above, when a processing function in the hardware entity (the apparatus of the present invention) described in the embodiment is implemented by a computer, processing content of a function that the hardware entity should have is described by a program. By executing this program using the computer, the processing function in the hardware entity is implemented on the computer.

A program in which processing content thereof has been described can be recorded on a computer-readable recording medium. The computer-readable recording medium may be, for example, a magnetic recording device, an optical disc, a magneto-optical recording medium, or a semiconductor memory. Specifically, for example, a hard disk apparatus, a flexible disk, a magnetic tape, or the like can be used as a magnetic recording apparatus, a DVD (Digital Versatile Disc), a DVD-RAM (Random Access Memory), a CD-ROM (Compact Disc Read Only Memory), CD-R (Recordable)/RW (ReWritable), or the like can be used as an optical disc, an MO (Magneto-Optical disc) or the like can be used as a magneto-optical recording medium, and an EEP-ROM (Electronically Erasable and Programmable-Read Only Memory) or the like can be used as a semiconductor memory.

Further, distribution of this program is performed, for example, by selling, transferring, or renting a portable recording medium such as a DVD or CD-ROM on which the program has been recorded. Further, the program may be distributed by being stored in a storage device of a server computer and transferred from the server computer to another computer via a network.

The computer that executes such a program first temporarily stores, for example, the program recorded on the portable recording medium or the program transferred from the server computer in a storage device of the computer. When executing the processing, the computer reads the program stored in its own storage device and executes the processing in accordance with the read program. Further, as another embodiment of the program, the computer may directly read the program from the portable recording medium and execute the processing according to the program, and further, processing according to a received program may be sequentially executed each time the program is transferred from the server computer to the computer. Further, a configuration in which the above-described processing is executed by a so-called ASP (Application Service Provider) type service for realizing a processing function according to only an execution instruction and result acquisition without transferring the program from the server computer to the computer may be adopted. It is assumed that the program in the present embodiment includes information provided for processing of an electronic computer and being pursuant to the program (such as data that is not a direct command to the computer, but has properties defining processing of the computer).

Although the hardware entity is provided by a computer executing a predetermined program, in the present embodiment, at least a part of the processing content may be implemented by hardware.

The foregoing description of the embodiments of the present invention has been presented for purposes of illustration and description. The foregoing description does not intend to be exhaustive and does not intend to limit the invention to the precise forms disclosed. Modifications and variations are possible from the teachings above. The embodiments have been chosen and expressed in order to provide the best demonstration of the principles of the present invention, and to enable those skilled in the art to utilize the present invention in numerous embodiments and with addition of various modifications suitable for actual use considered. All such modifications and variations are within the scope of the present invention defined by the appended claims that are interpreted according to the width provided justly lawfully and fairly.

1. An optimization function generation apparatus, comprising:
an input setting circuitry configured to set a set of staff members S, a set of vehicles C, a set of parking lots P, a delivery end time Close, a parking lot s.init (∈ P) with a staff members (∈ S) being present at a delivery start time, a cost s.cost for the staff member s per unit time, a parking lot c.init (∈ P) with a vehicle c (∈ C) being present at the delivery start time, a cost c.cost for the vehicle c per unit time, a maximum value c.capacity of staff members capable of boarding the vehicle c, a set of parking lots p.neighbors (⊆ P) neighboring to a parking lot p (∈ P), a time period p.time (q) required for moving from the parking lot p to a parking lot q (∈ p.neighbors) neighboring to the parking lot p, and a number p.shortage of vehicles to be still accommodated in the parking lot p, as input of a delivery planning problem for generating, under predetermined constraint conditions, a plan for delivering a vehicle to a parking lot short of vehicles to be parked, so as to satisfy a condition for minimizing a total of a staff cost and a vehicle cost incurred until the delivery end time Close (hereinafter, referred to as an optimization condition); and
an optimization function generation circuitry configured to generate an optimization function for variables representing quantum states for solving the delivery planning problem by using the input.

2. The optimization function generation apparatus according to claim 1, wherein
the predetermined constraint conditions include
a condition that, when the staff member s ∈ S is in the vehicle c ∈ C from a time t to a time t+1, a parking lot with the staff member s being present and a parking lot with the vehicle c being present, at the time t coincide (hereinafter, referred to as a first constraint condition),
a condition that, when the staff member s E S is in the vehicle c E C from the time t to the time t+1, a parking lot with the staff member s being present and a parking lot with the vehicle c being present, at the time t+1 coincide (hereinafter, referred to as a second constraint condition),
a condition that, when the staff member s ∈ S is not in a vehicle from the time t to the time t+1, a parking lot with the staff members being present at the time t and a parking lot with the staff member s being present at the time t+1 coincide (hereinafter, referred to as a third constraint condition),
a condition that, when the vehicle c ∈ C is in the parking lot p ∈ P at the time t, the vehicle c either moves to the parking lot q ∈ p.neighbors neighboring to the parking lot p during the time period p.time (q) or the vehicle c does not move and is present in the parking lot p even at the time t+1 (hereinafter, referred to as a fourth constraint condition),
a condition that one to c.capacity staff members are needed for delivering the vehicle c ∈ C (hereinafter, referred to as a fifth constraint condition), and a condition that p.shortage or greater vehicles are present in the parking lot p ∈ P at the delivery end time Close (hereinafter, referred to as a sixth constraint condition), and
the optimization function is a function having a minimum value only when all of the first constraint condition, the second constraint condition, the third constraint condition, the fourth constraint condition, the fifth constraint condition, and the sixth constraint condition are satisfied.

3. The optimization function generation apparatus according to claim 2, wherein
the variables representing the quantum states are quantum bits indicating a certain state by 1 and another state by 0,
the optimization function is a QUBO objective function defined by referring to a function expressing the first constraint condition, a function expressing the second constraint condition, a function expressing the third constraint condition, a function expressing the fourth constraint condition, a function expressing the fifth constraint condition, a function expressing the sixth constraint condition, and a function expressing the optimization condition,
the function expressing the first constraint condition is a function having a value of 0 when the first constraint condition is satisfied, and otherwise, a value greater than 0,
the function expressing the second constraint condition is a function having a value of 0 when the second constraint condition is satisfied, and otherwise, a value greater than 0,
the function expressing the third constraint condition is a function having a value of 0 when the third constraint condition is satisfied, and otherwise, a value greater than 0,
the function expressing the fourth constraint condition is a function having a value of 0 when the fourth constraint condition is satisfied, and otherwise, a value greater than 0,
the function expressing the fifth constraint condition is a function having a value of 0 when the fifth constraint condition is satisfied, and otherwise, a value greater than 0,
the function expressing the sixth constraint condition is a function having a value of 0 when the sixth constraint condition is satisfied, and otherwise, a value greater than 0, and
the function expressing the optimization condition is a function defined to have a smaller value as the total is smaller.

4. The optimization function generation apparatus according to claim 2, wherein
the variables representing the quantum states are spins indicating a certain state by 1 and another state by −1,
the optimization function is an Ising Hamiltonian defined by referring to a function expressing the first constraint condition, a function expressing the second constraint condition, a function expressing the third constraint condition, a function expressing the fourth constraint condition, a function expressing the fifth constraint condition, a function expressing the sixth constraint condition, and a function expressing the optimization condition,
the function expressing the first constraint condition is a function having a value of 0 when the first constraint condition is satisfied, and otherwise, a value greater than 0,
the function expressing the second constraint condition is a function having a value of 0 when the second constraint condition is satisfied, and otherwise, a value greater than 0,
the function expressing the third constraint condition is a function having a value of 0 when the third constraint condition is satisfied, and otherwise, a value greater than 0,
the function expressing the fourth constraint condition is a function having a value of 0 when the fourth constraint condition is satisfied, and otherwise, a value greater than 0,
the function expressing the fifth constraint condition is a function having a value of 0 when the fifth constraint condition is satisfied, and otherwise, a value greater than 0,
the function expressing the sixth constraint condition is a function having a value of 0 when the sixth constraint condition is satisfied, and otherwise, a value greater than 0, and
the function expressing the optimization condition is a function defined to have a smaller value as the total is smaller.

5. The optimization function generation apparatus according to claim 3, wherein
the variables representing the quantum states include
a variable defined to express a state where the vehicle c is in the parking lot p at the time t by a value of 1,
a variable defined to express a state where the vehicle c is moving at the time t by a value of 1,
a variable defined to express a state where the staff member s is in the parking lot p at the time t by a value of 1,
a variable defined to express a state where the staff member s is moving at the time t by a value of 1,
a variable defined to express a state where the staff member s is in the vehicle c from the time t to the time t+1 by a value of 1, and
a variable defined to express a state where the staff member s is not in any vehicle from the time t to the time t+1 by a value of 1.

6. An optimization function generation method, comprising:
setting, by an optimization function generation apparatus, a set of staff members S, a set of vehicles C, a set of parking lots P, a delivery end time Close, a parking lot s.init (∈ P) with a staff member s (∈ S) being present at a delivery start time, a cost s.cost for the staff member s per unit time, a parking lot c.init (∈ P) with a vehicle c (∈ C) being present at the delivery start time, a cost c.cost for the vehicle c per unit time, a maximum value c. capacity of staff members capable of boarding the vehicle c, a set of parking lots p.neighbors (⊆P) neighboring to a parking lot p (∈ P), a time period p.time (q) required for moving from the parking lot p to a parking lot q (∈ p.neighbors) neighboring to the parking lot p, and a number p.shortage of vehicles to be still accommodated in the parking lot p, as input of a delivery planning problem for generating, under predetermined constraint conditions, a plan for delivering a vehicle to a parking lot short of vehicles to be parked, so as to satisfy a condition for minimizing a total of a staff cost and a vehicle cost incurred until the delivery end time Close (hereinafter, referred to as an optimization condition); and
generating, by the optimization function generation apparatus, an optimization function for variables representing quantum states for solving the delivery planning problem by using the input.

7. A non-transitory computer-readable recording medium storing a program causing a computer to function as the optimization function generation apparatus according to claim 1.

8. The optimization function generation apparatus according to claim 4, wherein
the variables representing the quantum states include
a variable defined to express a state where the vehicle c is in the parking lot p at the time t by a value of 1,
a variable defined to express a state where the vehicle c is moving at the time t by a value of 1,
a variable defined to express a state where the staff member s is in the parking lot p at the time t by a value of 1,
a variable defined to express a state where the staff member s is moving at the time t by a value of 1,
a variable defined to express a state where the staff member s is in the vehicle c from the time t to the time t+1 by a value of 1, and
a variable defined to express a state where the staff member s is not in any vehicle from the time t to the time t+1 by a value of 1.
